(19) United States
(12) Patent Application Publication
(10) Pub. No.: US 2014/0240758 A1
(43) Pub. Date: Aug. 28, 2014

(54) IMAGE FORMING APPARATUS, IMAGE FORMING METHOD, AND NON-TRANSITORY COMPUTER READABLE MEDIUM

(71) Applicant: FUJI XEROX CO., LTD., Tokyo (JP)

(72) Inventor: Tomokazu YOSHIMURA, Kanagawa (JP)

(73) Assignee: FUJI XEROX CO., LTD., Tokyo (JP)

(21) Appl. No.: 13/957,076

(22) Filed: Aug. 1, 2013

(30) Foreign Application Priority Data
Feb. 28, 2013 (JP) 2013-039547

(51) Int. Cl. H04N 1/21

(52) U.S. Cl. CPC H04N 1/21
USPC 358/1.15

(57) ABSTRACT

An image forming apparatus includes a communication unit that communicates with multiple external image forming apparatuses each storing print data that is held until after printing is executed and identification information about a user, which is associated with the print data; a memory that stores print data and identification information about a user, which is associated with the print data; and a search unit that, upon specification of the identification information about the user, sequentially searches pieces of information stored in the memory and the multiple external image forming apparatuses for information corresponding to the specified identification information about the user and stops the search of the pieces of information stored in the memory and the multiple external image forming apparatuses, which are not searched, in response to a first search result that is achieved.

### CROSS-REFERENCE TO RELATED APPLICATIONS

This application is based on and claims priority under 35 USC 119 from Japanese Patent Application No. 2013-039547 filed Feb. 28, 2013.

### BACKGROUND

### Technical Field

The present invention relates to an image forming apparatus, an image forming method, and a non-transitory computer readable medium.

### SUMMARY

According to an aspect of the invention, there is provided an image forming apparatus including a communication unit that communicates with multiple external image forming apparatuses each storing print data that is held until after printing is executed and identification information about a user, which is associated with the print data; a memory that stores print data and identification information about a user, which is associated with the print data; and a search unit that, upon specification of the identification information about the user, sequentially searches pieces of information stored in the memory and the multiple external image forming apparatuses for information corresponding to the specified identification information about the user and stops the search of the pieces of information stored in the memory and the multiple external image forming apparatuses, which are not searched, in response to a first search result that is achieved.

### BRIEF DESCRIPTION OF THE DRAWINGS

Exemplary embodiments of the present invention will be described in detail based on the following figures, wherein:

FIG. 1 is a schematic view illustrating an example of the configuration of an image forming system;

FIG. 2 is a block diagram illustrating an example of the configuration of an image forming apparatus;

FIG. 3 is a schematic view illustrating an example of the structure of data storage box information;

FIG. 4 is a schematic view illustrating an example of the structure of a search result display screen;

FIGS. 5A to 5D are schematic views for illustrating an example of a basic operation of the image forming apparatus; and

FIG. 6 is a flowchart for illustrating an exemplary search process of the image forming apparatus.

### DETAILED DESCRIPTION

### Exemplary embodiments

### (Configuration of Image Forming System)

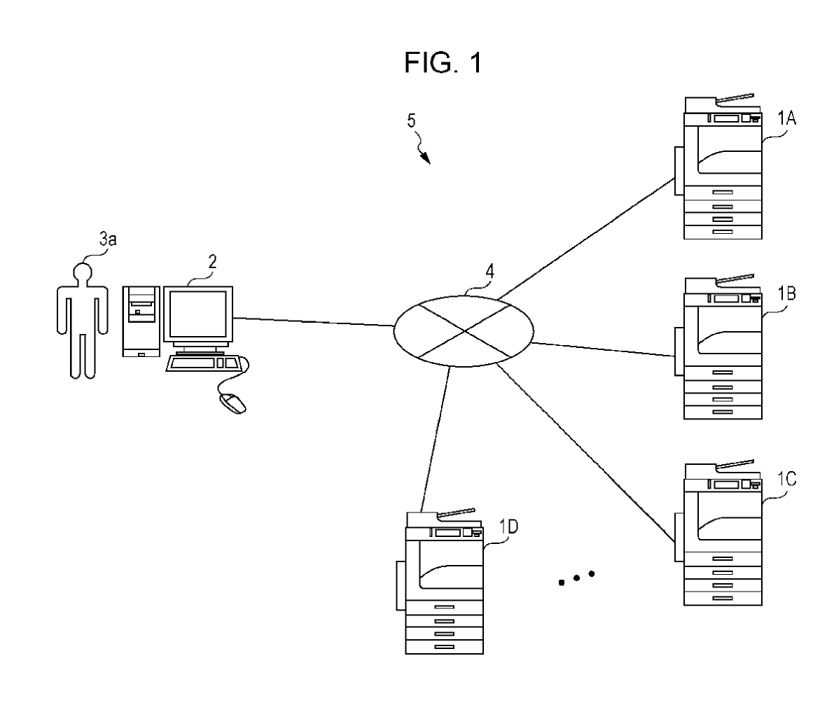

FIG. 1 is a schematic view illustrating an example of the configuration of an image forming system.

Referring to FIG. 1, an image forming system 5 has a configuration in which image forming apparatuses 1A to 1D and a terminal apparatus 2 are connected to each other so as to enable communication via a network 4. Although one terminal apparatus 2 is illustrated in FIG. 1, the image forming system 5 may include multiple terminal apparatuses connected to each other. The image forming apparatuses 1A to 1D are part of multiple image forming apparatuses.

Each of the image forming apparatuses 1A to 1D is a multifunction apparatus that at least has a printing function and further has scanner, copier, and facsimile functions. The image forming apparatuses 1A to 1D each include electronic components including a central processing unit (CPU) having an information processing function and a non-volatile memory. Each of the image forming apparatuses 1A to 1D receives print data from the terminal apparatus 2 and, then, prints the print data received from a user 3a upon acceptance of a print request by an operation by the user 3a.

The terminal apparatus 2 is an information processing apparatus, such as a personal computer (PC). The terminal apparatus 2 includes electronic components including a CPU having the information processing function and a flash memory. The terminal apparatus 2 generates the print data from document data upon acceptance of a print request by an operation by the user 3a and transmits the print data to the image forming apparatuses 1A to 1D. The print data has, for example, a Page Description Language (PDL) format.

The network 4 is a communication network capable of high-speed communication. The network 4 is, for example, a private communication network, such as an intranet or a local area network (LAN), or a public communication network, such as the Internet. The network 4 may be a wired network or a wireless network.

### (Configuration of Image Forming Apparatus)

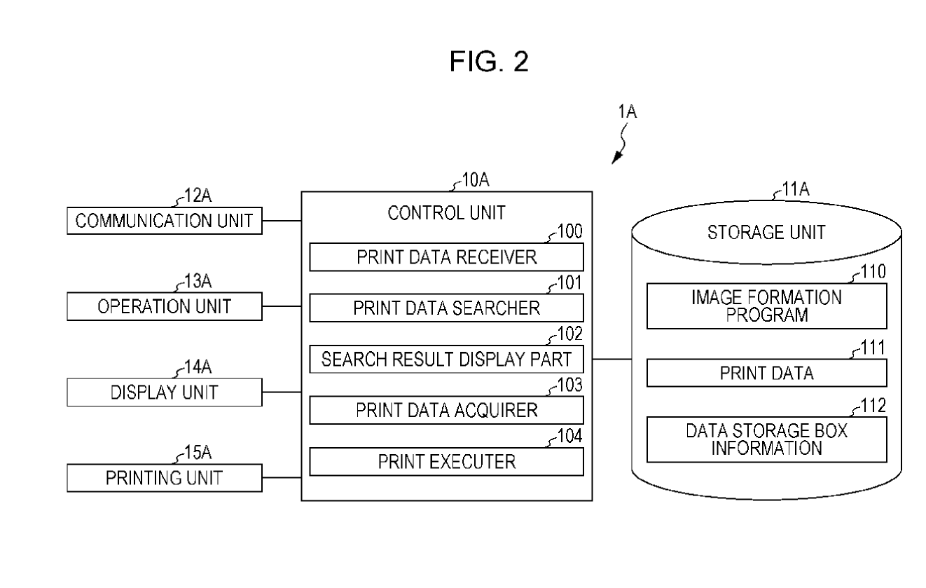

FIG. 2 is a block diagram illustrating an example of the configuration of the image forming apparatus 1A. Since the image forming apparatuses 1A to 1D have a common configuration, the image forming apparatuses 1A to 1D are typified by the image forming apparatus 1A for description.

Referring to FIG. 2, the image forming apparatus 1A includes a control unit 10A, a storage unit 11A, a communication unit 12A, an operation unit 13A, a display unit 14A, and a printing unit 15A. The control unit 10A is composed of a CPU or the like, controls each component in the image forming apparatus 1A, and executes various programs. The storage unit 11A is composed of a storage medium, such as a flash memory, and stores information. The communication unit 12A communicates with an external apparatus via the network 4. The operation unit 13A is used to operate the image forming apparatus 1A. The display unit 14A displays, for example, characters and/or images. The printing unit 15A performs printing on a sheet of paper.

The control unit 10A executes an image formation program 110 described below to function as, for example, a print data receiver 100, a print data searcher 101, a search result display part 102, a print data acquirer 103, and a print executer 104.

The print data receiver 100 receives print data 111 from the terminal apparatus 2 and stores the received print data 111 in the storage unit 11A. Specifically, the print data receiver 100 creates a folder called a box for every user to store the print data in the corresponding box and generate data storage box information 112 indicating the correspondence between the box, the user, and the print data.

The print data searcher 101 searches the storage unit 11A in the image forming apparatus 1A and storage units 11B to 11D in the other image forming apparatuses 1B to 1D, respectively, for the pieces of print data accumulated by the user who operates the image forming apparatus 1A. The print data searcher 101 refers to the data storage box information 112 in the search.

The search result display part 102 displays a list of print data names in the display unit 14A as an example of the result of the search by the print data searcher 101.

The print data acquirer 103 acquires the piece of print data that is selected by the user from the result of the search displayed by the search result display part 102 from the storage units 11A to 11D where the pieces of print data are accumulated.

The print executer 104 performs the printing on a sheet of paper in the printing unit 15A on the basis of the print data acquired by the print data acquirer 103.

The storage unit 11A stores the image formation program 110, the print data 111, the data storage box information 112, and so on causing the control unit 10A to operate as the print data receiver 100 to the print executer 104.

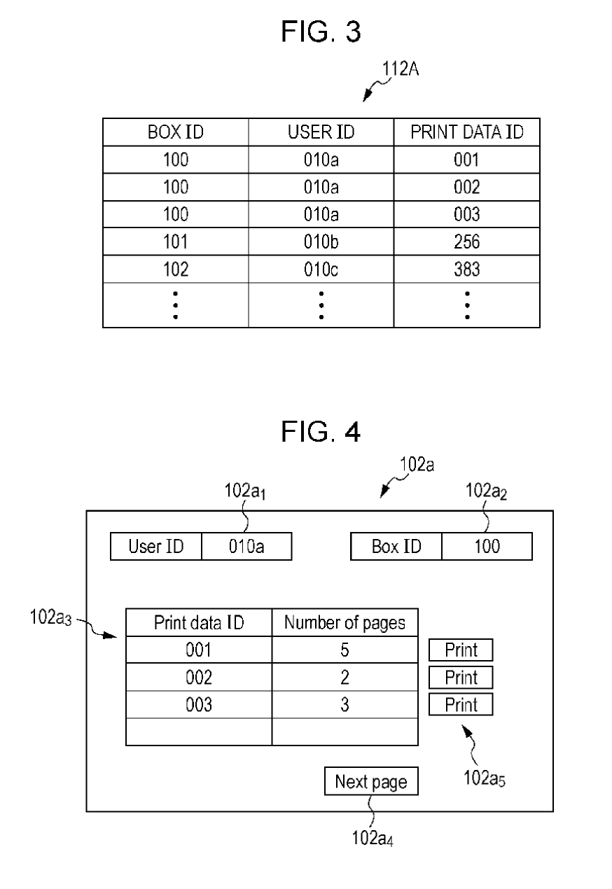

FIG. 3 is a schematic view illustrating an example of the structure of the data storage box information 112.

Data storage box information 112A indicates the relationship between the print data and the box where the print data is stored. The data storage box information 112A is used to associate a box identifier (ID), which is identification information about the created box, a user ID, which is the identification information about the user corresponding to the box ID, and a print data ID, which is the identification information about the print data stored in the box having the box ID, with each other.

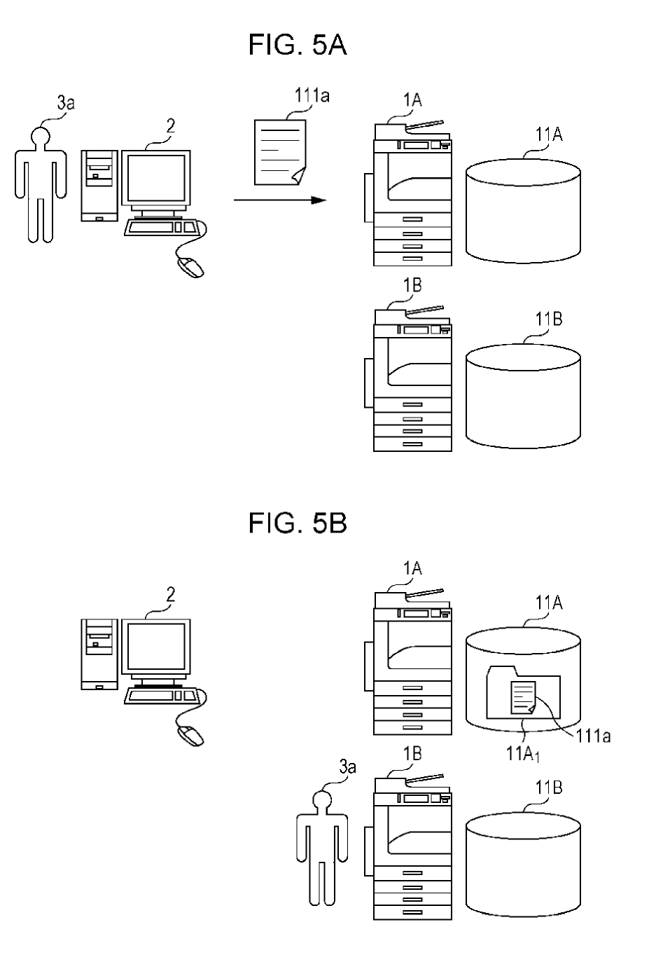

FIG. 4 is a schematic view illustrating an example of the structure of a search result display screen.

A search result display screen 102a is displayed in the display unit 14A in the image forming apparatus 1A. The search result display screen 102a includes a user ID field 102a₁ where the identification information about the user who is using the image forming apparatus 1A is displayed; a box ID field 102a₂ where the identification information about the box where the pieces of print data accumulated by the user is stored is displayed; a search result field 102a₃ where the identifier of the print data resulting from the search and the number of pages are displayed; a button 102a₄ used to display the next page if the print data resulting from the search is not fitted into the search result field 102a₃; and a button 102a₅ used to instruct the printing of the print data. The button 102a₄ and the button 102a₅ are capable of being selected in response to an operation with the operation unit 13A.

### (Operations of Image Forming Apparatus)

Operations according to the present exemplary embodiment will now be described. The operations include (1) a basic operation and (2) a search operation.

### (1) Basic Operation

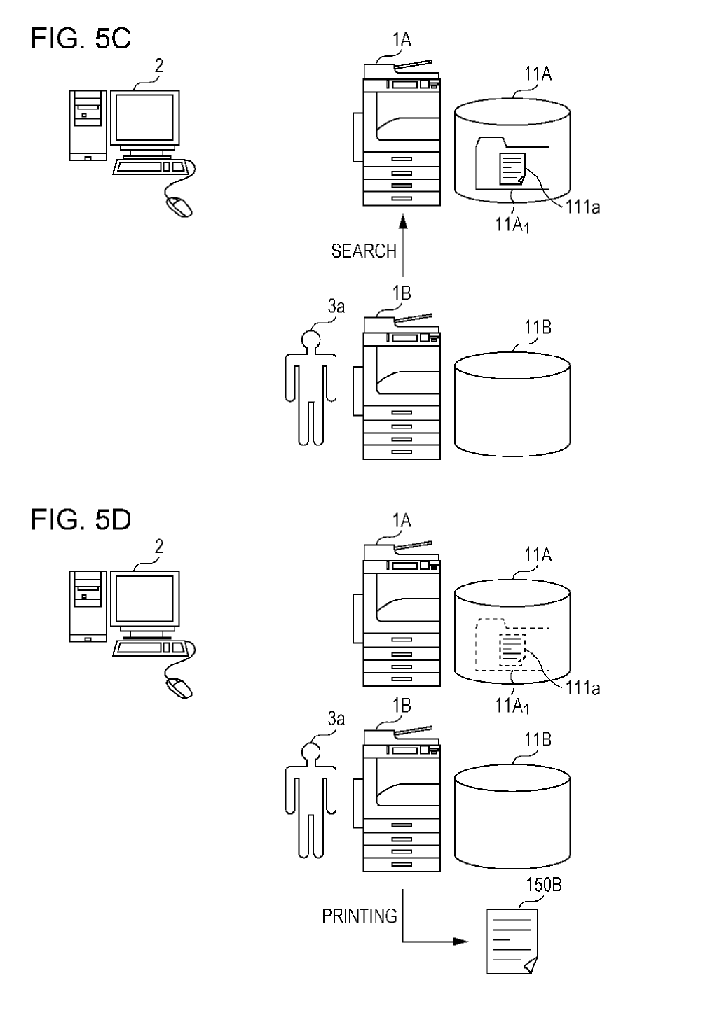

FIGS. 5A to 5D are schematic views for illustrating an example of the basic operation of the image forming apparatus. Only the image forming apparatus 1A and the image forming apparatus 1B, among the image forming apparatuses 1A to 1D, are illustrated for simplicity.

First, as illustrated in FIG. 5A, the user 3a operates the terminal apparatus 2 to log in the terminal apparatus 2 and requests the printing of the document data. It is sufficient to identify the user who is using the terminal apparatus 2 in the login to the terminal apparatus 2. For example, the user may input the user ID and a password to log in the terminal apparatus 2. Alternatively, the user may carry an ID card and data on the ID card may be read out by a reader (not illustrated).

The terminal apparatus 2 generates print data 111a from the document data in response to the print request by an operation by the user 3a and transmits the print data 111a to the image forming apparatus 1A. The user ID for identifying the user 3a is simultaneously transmitted along with the print data 111a.

Then, as illustrated in FIG. 5B, the print data receiver 100 in the image forming apparatus 1A receives the print data 111a to generate a box 11A₁ corresponding to the user 3a in the storage unit 11A and store the print data 111a in the box 11A₁. In addition, the print data receiver 100 receives the user ID and registers the IDs of the print data 111a and the box 11A₁ and the user ID in the data storage box information 112 in association with each other.

The user 3a, then, moves to a position where the image forming apparatus 1B is installed and operates an operation unit 13B of the image forming apparatus 1B to log in the image forming apparatus 1B. The user 3a, then, requests the search of the accumulated pieces of print data 111a. It is sufficient to identify the user who is using the image forming apparatus 1B in the login to the image forming apparatus 1B. For example, the user may input the user ID and a password to log in the image forming apparatus 1B. Alternatively, the user may carry an ID card and data on the ID card may be read out by a reader (not illustrated).

Then, as illustrated in FIG. 5C, the print data searcher 101 in the image forming apparatus 1B refers to the pieces of data storage box information 112 in the respective storage units 11A to 11D in order to search the storage unit 11B and the storage units 11A, 11C, and 11D in the other image forming apparatuses 1A, 1C, and 1D, respectively, for the pieces of print data 111a accumulated by the user 3a who operates the image forming apparatus 1B. The search operation will be described in detail in (2) Search operation.

The search result display part 102 in the image forming apparatus 1B displays the list of print data names in a display unit 14B as the result of the search by the print data searcher 101.

The user 3a confirms the display in the display unit 14B and operates an operation unit 13B to select the piece of print data 111a the printing of which the user wants from the list of the pieces of print data.

The print data acquirer 103 in the image forming apparatus 1B acquires the piece of print data 111a selected by the user from the storage unit 11A where the pieces of print data 111a are accumulated.

Then, as illustrated in FIG. 5D, the print executer 104 performs the printing on a sheet of paper with a printing unit 15B on the basis of the piece of print data 111a acquired by the print data acquirer 103 to output a printed material 150B.

The print data 111a is held until after the printing of the print data 111a is executed and is deleted from the box 11A₁ in the storage unit 11A upon completion of the printing. The box 11A₁ is deleted from the storage unit 11A when no print data to be stored exists.

### (2) Search Operation

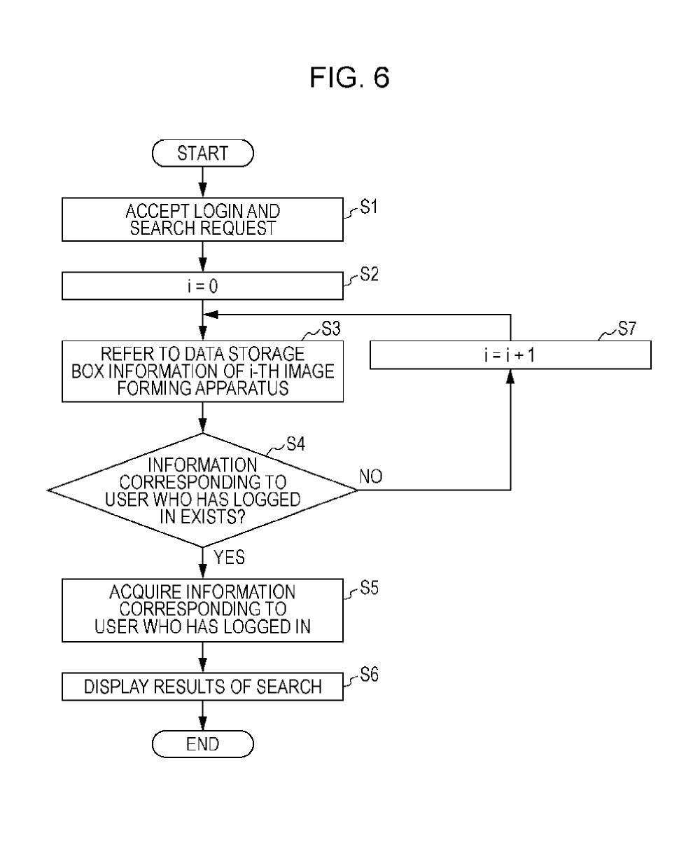

FIG. 6 is a flowchart for illustrating an exemplary search process of the image forming apparatus. Although the operation of the image forming apparatus 1B is illustrated in FIG. 6, the image forming apparatuses 1A, 1C, and 1D operate in the same manner as in the image forming apparatus 1B.

Referring to FIG. 6, in Step S1, the print data searcher 101 in the image forming apparatus 1B accepts the login of the user 3a and the search request for the print data. In Step S2, the print data searcher 101 sets i to zero (i=0), where i denotes the sequence number of the image forming apparatus, to access the storage unit of the first image forming apparatus, for example, the storage unit 11B in the own image forming apparatus 1B. In Step S3, the print data searcher 101 refers to data storage box information 112B of the image forming apparatus 1B.

In Step S4, the print data searcher 101 determines whether information (a user ID “010a”) corresponding to the user 3a who has logged in the data storage box information 112B in the image forming apparatus 1B exists. If the information (the user ID “010a”) corresponding to the user 3a who has logged in the data storage box information 112B in the image forming apparatus 1B does not exist (NO in Step S4), in Step S7, i=i+1=0+1=1. Then, the process goes back to Step S3.

Then, the print data searcher 101 sets i to one (i=1) to access, for example, the storage unit 11A in the image forming apparatus 1A and refers to the data storage box information 112A illustrated in FIG. 3.

If the information (the user ID “010a”) corresponding to the user 3a who has logged in the data storage box information 112A in the image forming apparatus 1A exists (YES in Step S4), in Step S5, the information corresponding to the user 3a who has logged in, that is, information about pieces of print data “001”, “002”, and “003” corresponding to a box ID “100” and the user ID “010a” is acquired.

In other words, if the information corresponding to the user 3a who has logged in exists in Step S4, the print data searcher 101 stops the search in the subsequent image forming apparatuses.

In Step S6, the search result display part 102 displays the list of the pieces of print data in the display unit 14B as the result of the search by the print data searcher 101, as in the manner illustrated in FIG. 4.

### Other Exemplary Embodiments

While the exemplary embodiments of the invention have been described above, the present invention is not limited to the above exemplary embodiments and it will be recognized and understood that various modifications may be made in the invention. For example, after displaying the result of the first search in Step S6 in FIG. 6, the process may go to Step S7 to repeat Steps S3 to S5. In other words, since the information corresponding to the users who have also logged in the image forming apparatuses 1C and 1D may exist even if the information corresponding to the user who has logged in the image forming apparatus 1A exists, the information corresponding to the user who has logged in may be searched again after displaying the result of the first search to additionally display the result of the re-search. The re-search may be performed only once or multiple times.

When the re-search is performed multiple times, a condition to stop the re-search may be set. For example, if the sum of the number of times of the re-search exceeds a maximum number of four of the print data IDs in the search result field 102a₃ on the search result display screen 102a illustrated in FIG. 4, the re-search may be stopped.

Alternatively, if the sum of the number of times of the re-search exceeds a predetermined multiple (“8”, “12”, “16”, . . . ) of the maximum number of the print data IDs in the search result field 102a₃ on the search result display screen 102a, which is equal to four, the re-search may be stopped. For example, when the predetermined multiple is set to “3”, the 12 results of the search corresponding to three pages are displayed in the search result field 102a₃.

Alternatively, the correspondence between i=0, 1, 2, . . . in FIG. 6 and the image forming apparatuses 1A to 1D, that is, the order of search may be managed with a list that is created in advance or a list created according to a predetermined rule. For example, the own apparatus may constantly have a value of zero for i (i=0) or the order of search may be set in accordance with the distances from a seat on which the user sits to the image forming apparatuses 1A to 1D. Alternatively, the order of search may be set in accordance with the frequencies at which the user transmits the print data to the image forming apparatuses.

Alternatively, on the basis of information with which the position of the user is managed, for example, information about the floor where the user exists, the image forming apparatuses installed on the same floor as the one where the user exists may be searched by priority.

If the time of a day or the day of a week when the power of the image forming apparatus is shut off is set in advance and the search is performed at timing corresponding to the time of a day or the day of a week, the image forming apparatus the power of which is shut off may be excluded from the search target.

Although the functions of the print data receiver 100 to the print executer 104 in the control unit 10A are realized by the programs in the above exemplary embodiments, all or part of the print data receiver 100 to the print executer 104 may be realized by hardware, such as an application specific integrated circuit (ASIC). Alternatively, the programs used in the above exemplary embodiments may be stored on a recording medium, such as a compact disk-read only memory (CD-ROM), and the programs stored on the recording medium may be supplied. Replacement, deletion, addition, or the like of the steps described in the above exemplary embodiments is available without departing from the spirit and the scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a communication unit configured to communicate with a plurality of external image forming apparatuses each storing print data that is held until after printing is executed and identification information about a user, which is associated with the print data;
a memory configured to store print data and identification information about a user, which is associated with the print data; and
a search unit configured to, upon specification of the identification information about the user, sequentially search pieces of information stored in the memory and the plurality of external image forming apparatuses for information corresponding to the specified identification information about the user and stop the search of the pieces of information stored in the memory and the plurality of external image forming apparatuses, which are not searched, in response to a first search result that is achieved.

2. The image forming apparatus according to claim 1,
wherein, upon acceptance of a re-search request, the search unit sequentially searches the pieces of information stored in the memory and the plurality of external image forming apparatuses, which are not searched, for the information corresponding to the specified identification information about the user and stops the search in response to a second search result that is achieved.

3. The image forming apparatus according to claim 1,
wherein the image forming apparatus further functions as a display that displays a result of the search by the search unit.

4. The image forming apparatus according to claim 3,
wherein the search unit sequentially searches the pieces of information stored in the memory and the plurality of external image forming apparatuses, which are not searched, for the information corresponding to the specified identification information about the user after the display displays the first search result and stops the search in response to the second search result that is achieved, and the display displays the second search result along with the first search result.

5. The image forming apparatus according to claim 3,
wherein the search unit sequentially searches the pieces of information stored in the memory and the plurality of external image forming apparatuses, which are not searched, for the information corresponding to the specified identification information about the user in response to the number of the first search results that is smaller than the number of search results fitted in a display area of the display and stops the search in response to a third search result that is achieved, a number resulting from addition of the number of the first search results to the number of the third search results being larger than or equal to the number of search results fitted in the display area of the display.

6. A non-transitory computer readable medium storing a program causing a computer to execute a process comprising:
communicating with a plurality of external image forming apparatuses each storing print data that is held until after printing is executed and identification information about a user, which is associated with the print data;
storing print data and identification information about a user, which is associated with the print data, in a memory; and
sequentially searching, upon specification of the identification information about the user, pieces of information stored in the memory and the plurality of external image forming apparatuses for information corresponding to the specified identification information about the user and stopping the search of the pieces of information stored in the memory and the plurality of external image forming apparatuses, which are not searched, in response to a first search result that is achieved.

7. An image forming method comprising:
communicating with a plurality of external image forming apparatuses each storing print data that is held until after printing is executed and identification information about a user, which is associated with the print data;
storing print data and identification information about a user, which is associated with the print data, in a memory; and
sequentially searching, upon specification of the identification information about the user, pieces of information stored in the memory and the plurality of external image forming apparatuses for information corresponding to the specified identification information about the user and stopping the search of the pieces of information stored in the memory and the plurality of external image forming apparatuses, which are not searched, in response to a first search result that is achieved.
